(19) United States
(12) Patent Application Publication
(10) Pub. No.: US 2006/0192965 A1
(43) Pub. Date: Aug. 31, 2006

(54) Method for assessing the condition of bone in-vivo

(76) Inventors: Bruce J. Tromberg, Irvine, CA (US); Anthony J. Durkin, Costa Mesa, CA (US); David Cuccia, Newport Beach, CA (US); Albert Cerussi, Lake Forest, CA (US); Sean Merritt, Lake Forest, CA (US); Natasha Shah, Irvine, CA (US)

Correspondence Address: Daniel L. Dawes;Myers Dawes Andras & Sherman LLP, Suite 1150, 19900 MacArthur Boulevard, Irvine, CA, 92612, US

(21) Appl. No.: 11/335,072

(22) Filed: Jan. 18, 2006

Related U.S. Application Data
(60) Provisional application No. 60/646,026, filed on Jan. 21, 2005.

(51) Int. Cl. G01N 21/00

(52) U.S. Cl. 356/432

(57) ABSTRACT

A method and apparatus for assessing bone tissue comprises the steps of and means for: exposing a sample to nonionizing radiation; detecting nonionizing radiation after transit in the bone tissue; measuring optical properties from the detected nonionizing radiation to characterize bone tissue across an entire selected spectral range using a continuous wave model, a frequency domain model or a combination of both wave model and frequency domain models; and determining composition, structure, physiology or a combination thereof of bone tissue from the measured optical properties.

### RELATED APPLICATIONS

The present application is related to U.S. Provisional Patent Application, Ser. No. 60/646,026, filed on Jan. 21, 2005, which is incorporated herein by reference and to which priority is claimed pursuant to 35 USC 119.

### GOVERNMENT RIGHTS

This invention was made with Government support under Grant No. RR01192 awarded by the NIH. The Government has certain rights in this invention.

### BACKGROUND OF THE INVENTION

1. Field of the Invention

The invention relates to the field of optical bone measurements and in particular to the use of measurement of optical parameters of bone and other tissue simultaneously to obtain tissue profiles on the bone and surrounding tissue.

2. Description of the Prior Art

In recent years, as reported by Takeuchi “A new method of bone tissue measurement based upon light scattering” Department of Internal Medicine IV, Saitama Medical School, Japan. J Bone Miner Res February 1997; 12(2):261-6, time-resolved spectroscopy systems using near infrared pulsed laser have been applied to develop optical computed tomography.

Urakami, et al., “Optical measuring method and an optical measuring apparatus for determining the internal structure of an object,” U.S. Pat. No. 5,774,223 (Jun. 30, 1998) is directed to an optical measuring method and an optical measuring apparatus capable of obtaining the true mean time delay of a light waveform within a short time for the purpose of obtaining information on the internal structure of an object. Calculations include a first mean time delay when the light path includes the object, a second mean time delay when the light path does not include the object, and a subtraction of the second mean time delay from the first mean time delay to obtain a true mean time delay.

If a correlation is gained between the condition of disease or the condition of body and the mean time delay measured, useful information can be acquired directly from the mean time delay data. For example, if there is a correlation between a change of measured value and a structural change of tissue, a degree of the structural change can be obtained from the change of mean time delay, utilizing the correlation. If the arithmetic processing of the analyzing unit 50 is set to one for acquiring the information concerning the structural change of measured object, the optical measuring apparatus shown in FIG. 2 and FIG. 3 can be applied to diagnosis of osteoporosis.

For example, as described in Araki et al., “Optical measurement of osteoporotic bone (1) (2)” (Abstracts at the 65th Meeting of the Japanese Society for Hygiene), a temporal waveform of light passing through an osseous tissue changed in the structure from a normal condition shows a change in a peak, a spread, a mean time delay, or the like of waveform depending upon the structural change. Explaining more specifically, the light passing through the tissue propagates therein as scattered, and thus, the frequency of chances to be scattered decreases with a coarse tissue structure so as to change the response waveform. With less scattering, the width of the waveform of output light becomes narrower, and the peak and mean time delay are shifted to the shorter time side, as compared with those of normal tissues. Accordingly, the information concerning the osteoporosis can be obtained by measuring the mean time delay of output light. In this case, the analyzing unit 50 can be set to perform an arithmetic algorithm to obtain a parameter indicating a change degree of the structure based on the mean time delay data. The teaching here refers vaguely to a method for manipulating time domain data acquired from tissue. There is insufficient detail provided to be enabling.

Marchitto, et al., “Optical measurements of bone composition,” U.S. Patent Application 20020002336 (Jan. 3, 2002) provides an non-invasive and inexpensive method and/or device for detecting a disease in a bone or other tissues using an optical fiber based Raman spectrometer by detecting biochemical changes in the bone or the other tissues. The described method for detecting a bone disease in a test subject comprises the steps of transmitting radiant energy to surface of skin overlaying a bone in the test subject; detecting radiant energy reflected from the skin surface to obtain Raman spectra, wherein the Raman spectra from the skin surface reflect the spectral information on the bone, which reflects biochemical compositions of the bone; and comparing the biochemical compositions of the test bone with those of a normal bone, wherein if the biochemical compositions of the test bone differ from those of the normal bone, the test subject might have a diseased bone. The radiant energy is transmitted through a fiber-optic based reflectance probe, reflected from the skin surface is collected by a fiber optic, and is near-infrared light having a wavelength range of from about 600 nm to about 1500 nm. The reflected radiant energy is filtered through a long-pass filter, a band-pass filter or a polarization filter. The method is used for detecting a bone disease, such as osteomalacia, osteoporosis, a bone cancer, or a bone infection.

### BRIEF SUMMARY OF THE INVENTION

The objects of the present invention include, but are not limited to: simultaneous determination of structural, biochemical, and functional changes in bone; a much more compact and inexpensive instrumentation than used to existing methods such as ultrasound and dual-energy x-ray absorptiometry (DEXA); and optical methods possess the same advantages in other tissues, thus allowing a single device for assessing tissue composition, structure, and physiology as well as bone.

The illustrated embodiment of the invention satisfies these objects and overcomes the following disadvantages. Several methods are available to measure bone density, but currently the most widely used technique is dual energy x-ray absorptiometry, which has been used to determine efficacy in recent large clinical trials, and to characterize fracture risk in large epidemiological studies. Newer techniques such as ultrasound appear to offer a more cost-effective method of screening bone mass. Ultrasound measurements are usually performed at the calcaneous and it is not possible to measure sites of osteoporotic fracture such as the hip or spine. Adding an ultrasound measurement to dual energy x-ray absorptiometry does not improve the prediction of fractures.

Although it is believed by some that ultrasound measures the “quality” of bone, more careful studies suggest that it mainly measures bone mass. Quantitative computed tomography (QCT) of the spine must be done following strict protocols in laboratories that do these tests frequently. In community settings the reproducibility is poor. The quantitative computed tomography measurements decrease more rapidly with aging, so the conventional T scores in older individuals will be much lower than dual energy x-ray absorptiometry measurements. A T score is the number of standard deviations the bone mineral density measurement is above or below the young-normal mean bone mineral density. Another conventional bone density measure is a Z score which is the number of standard deviations the measurement is above or below the age-matched mean bone mineral density.

Several techniques can measure bone density in the hand, radius or ankle. These techniques include single energy absorptiometry for metacarpal width or density from hand x-rays.

In the illustrated methods of the invention for assessing the condition of bone in-vivo using non-ionizing radiation, the use of non-ionizing radiation, including, but not limited to, the visible, near-infrared, and infrared spectral regions offer novel contrast mechanisms for monitoring the health or disease state of bone tissue.

The illustrated embodiment uses the techniques which include, but are not limited to:
a. A frequency domain photon migration (FDPM) as disclosed in U.S. Pat. No. 5,424,843, incorporated herein by reference, which discloses an apparatus and method for qualitative and quantitative measurements of optical properties of turbid media using frequency-domain photon migration;
b. A method and apparatus for performing quantitative analysis and imaging of subsurface heterogeneities of turbid media using spatially structured illumination as disclosed in U.S. Patent Application 2003/0184757 (Ser. No. 10/391,166) filed Mar. 18, 2003, incorporated herein by reference;
c. A combined frequency domain photon migration and broadband spectroscopy as disclosed in U.S. patent application Ser. No. 10/191,693, filed Jul. 9, 2002, incorporated herein by reference; and/or
d. Continuous wave broadband spectroscopy at multiple distances.

The illustrated embodiments of the invention use measured optical properties to characterize bone tissue viability. The optical properties of bone are strongly influenced by composition, structure, and physiology. Disease alters these bone characteristics, and thus bone optical properties are parameters that gauge bone disease progression. Optical methods offer rapid, noninvasively quantifiable parameters for characterizing many types of biological tissues, including bone. The indicators of bone disease may be the optical properties of the bone itself or the optical property difference between bone and other tissues. For example, a comparison between tibia and calf muscle optical properties could reflect the health or disease state of the bone. Spatial, temporal or other variations of bone optical properties may also be used as indicators of disease. Absolute values of bone optical properties compared across a population may also form the basis of characterizing bone disease. The optical properties can also be correlated or formulated to provide traditional measures of bone such as the T score. The common feature is the use of nonionizing optical spectra as the noninvasive probe of bone tissue.

Bone optical properties, including, but not limited to, the absorption and reduced scattering coefficients provide unique information that is not currently provided by traditional methods. Other measured optical properties, such as the scattering angular dependence, also provide tissue information. These optical properties may be measured at either at a single wavelength or over a range of wavelengths. Since bone is composed of collagen fibers, which will weaken during osteoporosis or injury, measurements of the anisotropy of non-ionizing optical scattering in bone (NIR, visible or IR) can be indicative of disease.

In bone there is also a large fraction of bound water: namely, water that is tightly hydrogen bound to macromolecules. This water binding creates a spectral signature in the near-infrared region that is significantly different from free water, namely water that is hydrogen bound to water only. In particular, there is a free water absorption peak located at ˜980 nm, but when water is bound to macromolecules this absorption peak will red shift as much as 15 nm. Broadband Doppler optical spectroscopy (DOS) has the ability to measure absolute absorption spectra and therefore characterize this bound water shift in bone. This bound water shift parameter may prove to be a useful diagnostic for bone density through a correlation between shift strength and bone mineral content. It may also simply be a guide for broadband DOS to target the bone during a measurement.

Bone marrow is greater than 80% lipids and therefore, broadband DOS has the ability to characterize this tissue through its absorption. There is a lipid absorption peak located at 926 nm in the near-infrared. Preliminary broadband DOS measurements have shown that in the bone marrow this lipid absorption peak is blue shifted a few nanometers, which is consistent with lipids improperly hydrogen bound to water. This spectral signature gives broadband DOS the ability to separate subcutaneous superficial lipids from lipids in the marrow and can act as a guide to bone marrow measurements. The strength of the lipid peak blue shift can prove to be useful as diagnostic parameter.

Several analysis styles may be applied to determine tissue optical properties. First, frequency domain photon migration (FDPM) may be used to measure the absorption and reduced scattering properties of bone in-vivo. Spectral changes in absorption provide compositional and physiological information about the bone tissue. For example, the near-infrared absorption spectrum provides the concentrations of oxygenated and deoxygenated hemoglobin, lipids, and water. Changes in water concentration may be indicative of bone disease. Spectral changes in reduced scattering depend upon the density and size of tissue scatterers. For example, the near-infrared scattering spectral dependence of tissue varies according to a power law of the wavelength. Both the power and scale factor of this dependence may be used to assess bone structure and density. In addition, the raw optical signals measured in FDPM such as amplitude, average intensity, modulation, and phase, can all be used alone to assess bone optical properties. Simple models of light transport may be used to determine the bone optical properties. Other approaches, including, but not limited to, light transport models, other physical models, and chemometric analysis of FDPM and spectroscopic signals, can also be applied to these raw signals.

Second, spatially structured illumination may be used to determine the optical properties of bone. This method can determine changes in the optical properties in bone tissue and locate inhomogeneities in bone structure or composition that could be indicative of disease. Any of the above methods may also be used for this purpose.

Finally, it should be noted that our capability to analyze tissue as a function of wavelength, illumination structure and/or source modulation frequency enables a novel ability to characterize bone structure and functional status.

The optical method described is unique in its capability of delivering detailed composition related to structure and function. In addition, there is potential opportunity for spectroscopy to provide information that may be related to bone health that is not provided by pre-existing methods which report only “density.” For example, it is known that hydration state of bone is related to mechanical strength, yet hydration status is not provided by any existing method for determining bone mineral density in vivo in living bone tissue. Using out approach, this information can be accessed in vivo in near real time.

Potential application areas include, but are not limited to, medical diagnostics and bone density assessment, such as used in: monitoring of therapeutic efficacy of hormone therapies and other anti-osteoporosis measures; monitoring changes in bone (and muscle) status resulting from microgravity; monitoring efficacy of countermeasures for slowing or reversing the effects of microgravity; monitoring recovery, healing, or treatment of bone tissue from trauma and atrophy; osteoporosis screening, diagnosis or response to therapies; and assessment of bone and muscle health in microgravity and response to therapeutic countermeasures.

In summary, the illustrated embodiment of the invention includes a method for assessing bone tissue comprising the steps of: exposing a sample to nonionizing radiation; detecting nonionizing radiation after transit in the bone tissue; measuring optical properties from the detected nonionizing radiation to characterize bone tissue across an entire selected spectral range using a continuous wave model, a frequency domain model or a combination of both wave model and frequency domain models; and determining composition, structure, physiology or a combination thereof of bone tissue from the measured optical properties.

The step of measuring optical properties comprises measuring optical properties at each point in an entire fingerprint region including at least 600-1100 nm or at least does not depend on arithmetic differences in tissue transit of light.

The step of measuring optical properties comprises a method for qualitative and quantitative measurements of optical properties of turbid media using frequency-domain photon migration, a method for performing quantitative analysis and imaging of subsurface heterogeneities of turbid media using spatially structured illumination, a method for combined frequency domain photon migration and broadband spectroscopy, or a method for continuous wave broadband spectroscopy at multiple distances.

The method further comprises the step of determining disease states based on altered bone characteristics, or determining bone disease progression based thereon.

The step of determining disease states comprises: comparing bone characteristics between selected bone tissue and selected muscle tissue; determining spatial, temporal or compositional variations of bone optical properties; and/or comparing absolute values of bone optical properties across a population.

The method further comprises the step of correlating the optical properties of bone to provide conventional measures of bone such as the T score.

The step of measuring optical properties to characterize bone tissue comprises: measuring the absorption and reduced scattering coefficients or scattering angular dependence from the bone tissue; measuring the anisotropy of nonionizing optical scattering in bone (NIR, visible or IR) can be indicative of disease; using broadband DOS to measure absolute absorption spectra and characterize bound water shift in bone; measuring a blue shift of a lipid absorption peak using Doppler optical spectroscopy (DOS) in bone to separate subcutaneous superficial lipids from lipids in the marrow; using frequency domain photon migration (FDPM) to measure the absorption and reduced scattering properties of bone in-vivo to determine spectral changes in absorption in order to provide compositional and physiological information about the bone tissue, including a near-infrared absorption spectrum to provide concentrations of oxygenated and deoxygenated hemoglobin, lipids, and water; measuring spectral changes in reduced scattering including the power and scale factor of near-infrared scattering spectral dependence of tissue as a function of the wavelength to assess bone structure and density; measuring optical signals in FDPM (amplitude, average intensity, modulation, and phase) to assess bone optical properties; using models of light transport, physical models, and chemometric analysis of FDPM and spectroscopic signals to determine the bone optical properties; using spatially structured illumination to determine the optical properties of bone to determine changes in the optical properties in bone tissue and locate inhomogeneities in bone structure or composition indicative of disease; and/or analyzing tissue as a function of wavelength, illumination structure, source modulation frequency or a combination thereof to characterize bone structure and functional status.

The method further comprises the step of performing medical diagnostics and bone density assessment based on the measurement and determination of bone tissue optical properties. The step of performing medical diagnostics and bone density assessment comprises: monitoring of therapeutic efficacy of hormone therapies and anti-osteoporosis measures; monitoring changes in bone and muscle status resulting from microgravity; monitoring efficacy of countermeasures for slowing or reversing the effects of microgravity; monitoring recovery, healing, or treatment of bone tissue from trauma and atrophy; screening osteoporosis for purpose of diagnosis or response to therapies; and/or assessing bone and muscle health in microgravity and responses to therapeutic countermeasures.

It must be further understood that the invention includes embodiments defined as apparatus having means for performing each of the above embodiments of methodology. Such means include light or nonionizing sources, detectors, cameras, recording devices and digital signal processors, computers, logic circuits, memories, display devices and other conventional components used in optical data acquisition and processing.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is a graph of the oxy/deoxy ratio and SₜO₂ in human bone as a function of age in human subjects.

FIG. 2 is a graph of the product of scatter power (SP) and oxy/deoxy ratio in human bone as a function of age in human subjects from the data of FIG. 1.

FIG. 3 is a graph of the product of scatter power (SP) and oxy/deoxy ratio divided by body mass index in human bone as a function of age in human subjects of FIGS. 1 and 2.

FIG. 4 is a diagram of a tibia showing two measurement geometries of a source and detector to measure in bone as a function of position along the longitudinal length of the tibia.

FIG. 5 is a graph of the reduced scattering coefficient measured ex vivo in three bovine tibia as a function of position and measurement geometry as depicted in FIG. 4.

FIG. 6 is a graph of the reduced scattering coefficient measured in vivo in a human subject as a function of position and measurement geometry as depicted in FIG. 4.

FIG. 7 shows in its upper portion a graph of the absorption coefficient spectra in bovine tibia as compared to the absorption coefficient spectra in human breast tissue. FIG. 7 shows in its lower portion a graph of the reduced scattering coefficient spectra in bovine tibia as compared to the absorption coefficient spectra in human breast tissue.

FIG. 8 is a graph of the absorption coefficient spectra in bovine tibia based on a steady state-frequency domain photon migration model assuming four chromophores showing the red shift of the water peak in the experimental data in dotted line as compared to the fitted data in solid line according to the assumed model.

FIG. 9 is in its left portion a graph of the absorption coefficient spectra in bovine tibia marrow based on a steady state-frequency domain photon migration model assuming four chromophores showing the blue shift of the water peak in the experimental data in dotted line as compared to the fitted data in solid line according to the assumed model. FIG. 9 in its right portion is a Doppler optical spectrogram of the cross section of bovine tibia corresponding to the left portion of the figure, where the measurements points in the marrow near the marrow-compact bone boundary are marked.

FIG. 10 is a bar chart of the ex vivo scattering coefficient in the tibia of four human subjects for the two measurement geometries of FIG. 4.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

Consider first an illustrated embodiment of the invention which begins with data collection. Measurements were performed in the center of the right shins of 14 female subjects. All data points represent an average of three measurements of the same location. Each measurement was obtained using a laser breast scanner.

Each measurement used a combined frequency-domain photon migration (FDPM) and steady-state (SS) measurement procedure as described in U.S. Pat. No. 5,424,843. FDPM data was acquired from ten laser diodes within the spectral rage of 660 to 980 nm. Source modulation frequencies ranged from 50 to 600 MHz. Steady-state spectra were acquired over the 600 to 1000 nm spectral range immediately after the FDPM measurement. Both FDPM and steady state measurements were performed in a reflectance geometry using a source-detector separation of 29 mm. It is within the scope of the invention that many other source-detector separation distances may be employed as desired in order to optimize the assessment of bone status.

The FDPM data was fitted to a P₁-Approximation to the Boltzmann transport equation in order to separate the effects of absorption from scattering within the tissue. Data presented below was fitted only from 50 to 400 MHz. The character of the fits is very different going out to 600 MHz for reasons that are unclear at present. The general trends of the fitted parameters are not noticeably affected by clipping the modulation frequency. We used only the first six diodes since they consistently represented the highest quality data. Again it is entirely within the scope of the invention that other kinds of light sources and other numbers of sources may be used without departing from the spirit and scope of the invention.

Once absorption and scattering coefficients were obtained, we integrated the steady state spectra using the technique described in U.S. patent application Ser. No. 10/191,693. Such a scheme provides absorption and scattering coefficients over the entire 650 to 1000 nm wavelength region. Absorption spectra were then fitted to the known extinction coefficients of oxy-hemoglobin (Hb-O₂), deoxy-hemoglobin (Hb-R), water, and lipids using a simple least-squares technique. Hemoglobin parameters are reported as concentrations (micromolar). Water and lipid values are reported as percentages of pure substance and do not represent true volume or mass fractions. Other parameters include the total hemoglobin concentration (THC=Hb-O₂+Hb-R) and the tissue hemoglobin saturation (SₜO₂=Hb-O₂/THC). Scattering spectra were quantified by a power law fit of the form A λ^{-S}, where A and S are referred to as the ‘prefactor’ and the ‘scatter power,’ respectively.

It is believed that the fat layer contribution to the optical signal is minimal using a source-detector separation of 29 mm as in the case of muscle measurements, although a two-layer model could also be adopted. Products of power law scattering parameters may better describe the true scattering nature of the tissue. Other conventional models of the scattering dependence are contemplated as being within the scope of the invention and are regarded as equivalent substitutions to that disclosed.

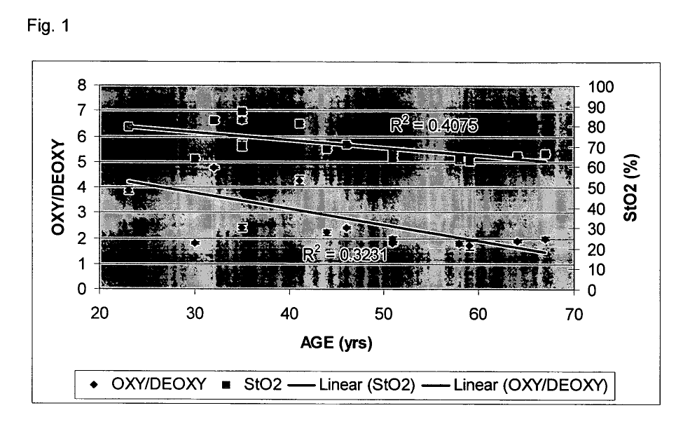

There is no real correlation of the total hemoglobin content (THC) or the deoxyhemoglobin (Hb-O₂ or deoxy) with age, although there is a mild increase of oxyhemoglobin (Hb-R or oxy) with age. However, both the oxy/deoxy ratio and the oxidized hemoglobin (SₜO₂) decrease with age, as shown in the graph of FIG. 1 where the oxy/deoxy ratio and the SₜO₂ are plotted as a function of age. Assuming that there should be some sort of age dependence, we can design parameters that reflect what bone parameter should change with age. The scattering will change with age because the cellular density drops as the bone weakens. A change in cellular density results in altered optical transport characteristics.

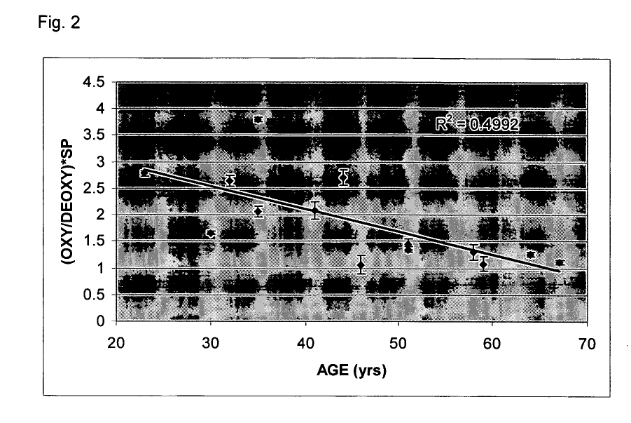

If we include the scatter power SP as a multiplicative factor with the oxy/deoxy ratio and plot the result against age, the graph of FIG. 2 results. This shows reasonably good correlation and in fact is better than a great deal of the ultrasound and DEXA data that has been published in clinical journals. There has not yet found to be much improvement in water is included, but our investigations on how to incorporate the role of water have not been exhaustive and are contemplated as within the scope of the invention.

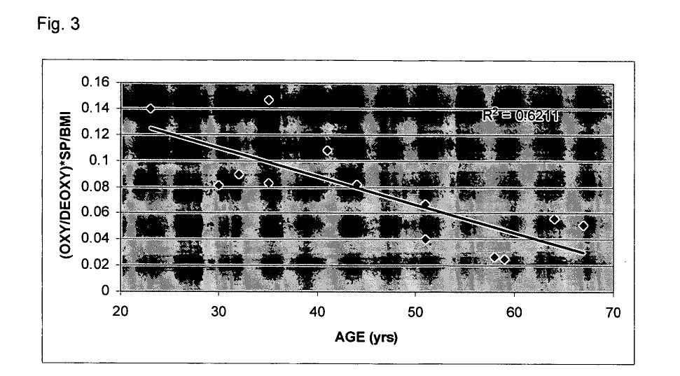

If we divide the scatter power-oxy/deoxy ratio product of FIG. 2 by the body mass index (BMI), the correlation improves even more. This is depicted in the graph of FIG. 3. Such a tactic is reasonable because some bone strength indices take BMI into account. Yet there is some weak age dependence BMI (R²=0.15) so that this effect may be artificial. Error bars are not plotted because error in BMI is unknown.

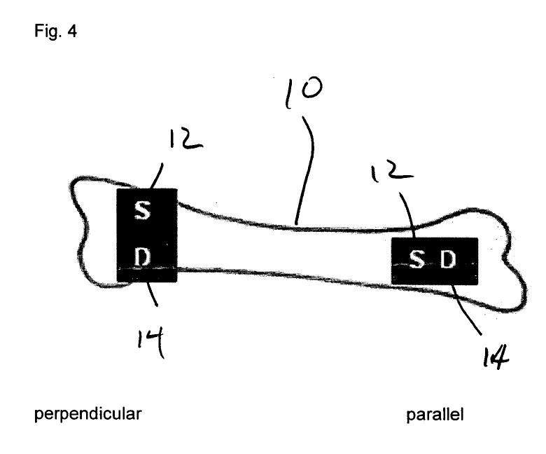

Turn now to anisotropic optical properties used for the assessment of bone mineral density, for monitoring integrity of structure in the bone (i.e. collagen fibers) and for monitoring neoadjuvant chemotherapy for osteogenic sarcomas. Measurements were performed on three intact hind shaft (tibial) bovine bones 10 ex vivo as symbolically depicted in FIG. 4. The tibias 10 were acquired one day post slaughter to mimic hydration properties most similar to in vivo tissue, cleaned of all tendons, cartilage and extraneous tissue and measured using steady state FDPM 2-days post-slaughter. Twelve (12) measurements were made along the tibia at 2 cm intervals from hoof to knee using a laser breast scanner employing 6 laser diodes at 650-850 nm and a steady-state light source at 650-1000 nm. Two measurement geometries were used: (1) “Parallel” where the source 12 and detector 14 were aligned along the long axis of the bone 10 as shown in the right end of FIG. 4 and (2) “perpendicular” where the source 12 and detector 14 were transverse the long axis of the bone 10 as shown in the right end of FIG. 4. Two measurements were made in each location in both geometries. The tibia 10 then was dissected along the long axis and measurements were made directly on the marrow inside the bone.

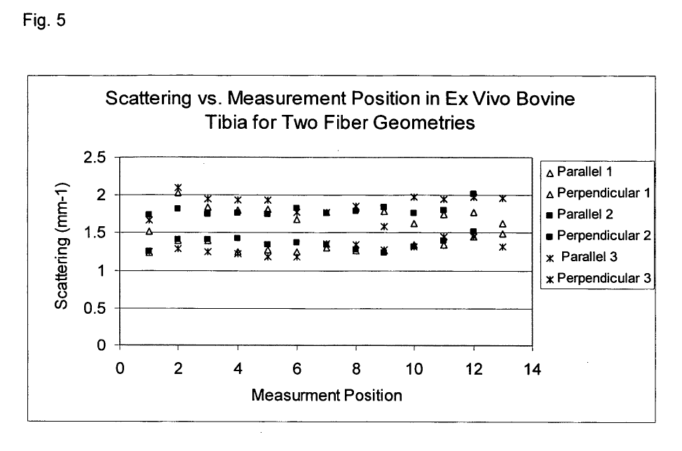

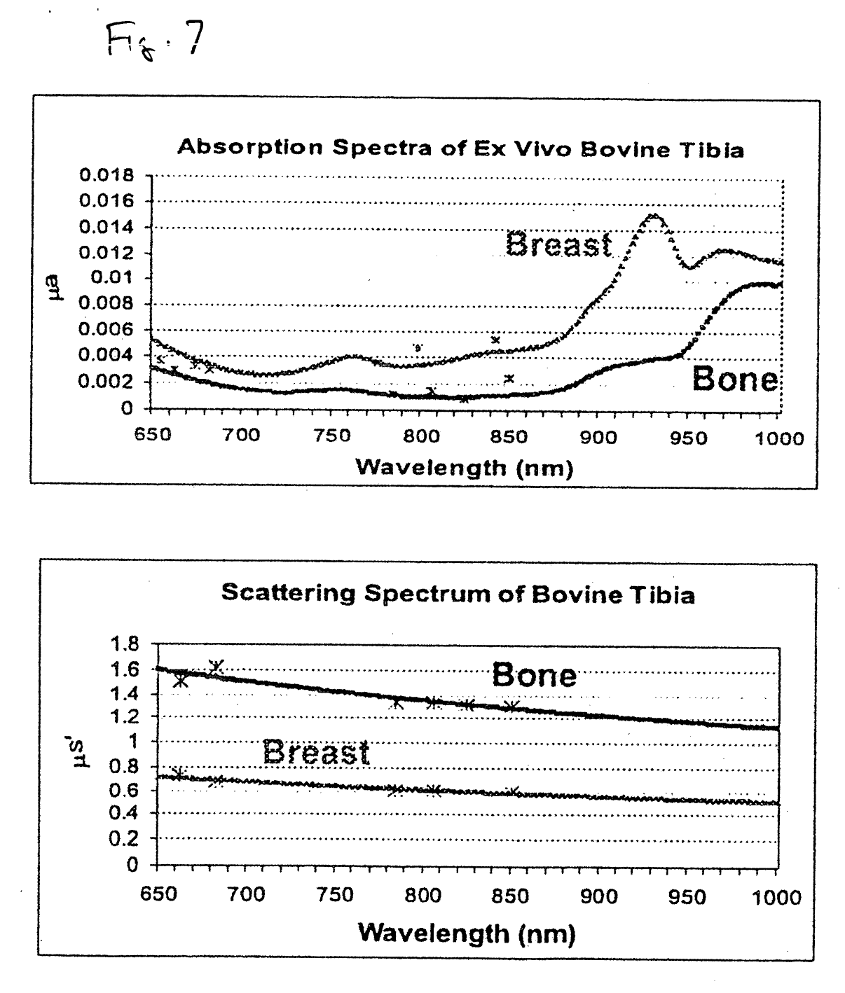

FIG. 7 is a graph which shows the absorption and reduced scattering coefficients spectra for the ex vivo bovine tibia as compared to data for human breast tissue for the 650-1000 nm range of the illustrated embodiment. It must be understood in each case, that the spectra range can be chosen to be greater or less than that illustrated. There is a strong scattering dependence based on the alignment of the source and detection fibers with respect to the long axis of the bone in the case of the bovine bone as shown in the graph of FIG. 5 where the reduced scattering coefficient is graphed against position of measurement. The “perpendicular” geometry shows a 20-60% greater reduced scattering coefficient at 661 nm than the “parallel” geometry (p<0.0001). Over all wavelengths there is an average 30% greater scattering in the perpendicular geometry.

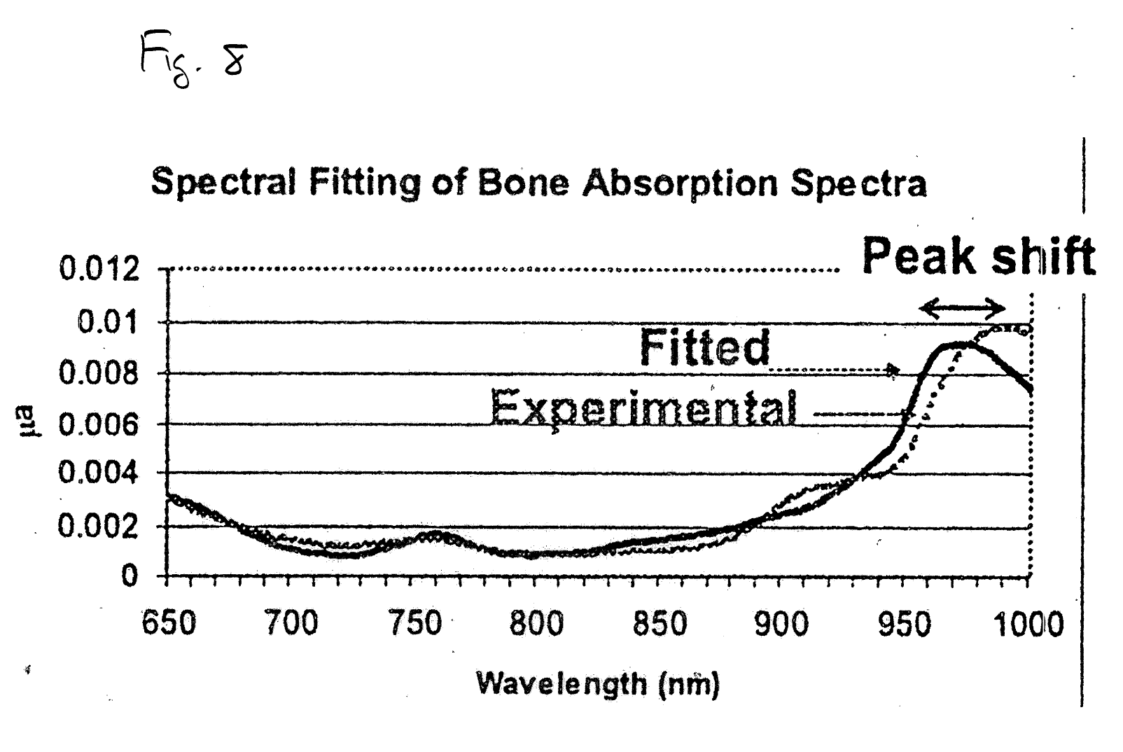

Fitting the bone data to a steady state-FDPM model which assumes four chromophores shows some consistent spectral differences as seen in the absorption spectra of FIG. 8. Macromolecules bound to water causes a red shift in the water peak and broadening of the spectrum as compared to the fitted model as seen by the dotted line of experimental data.

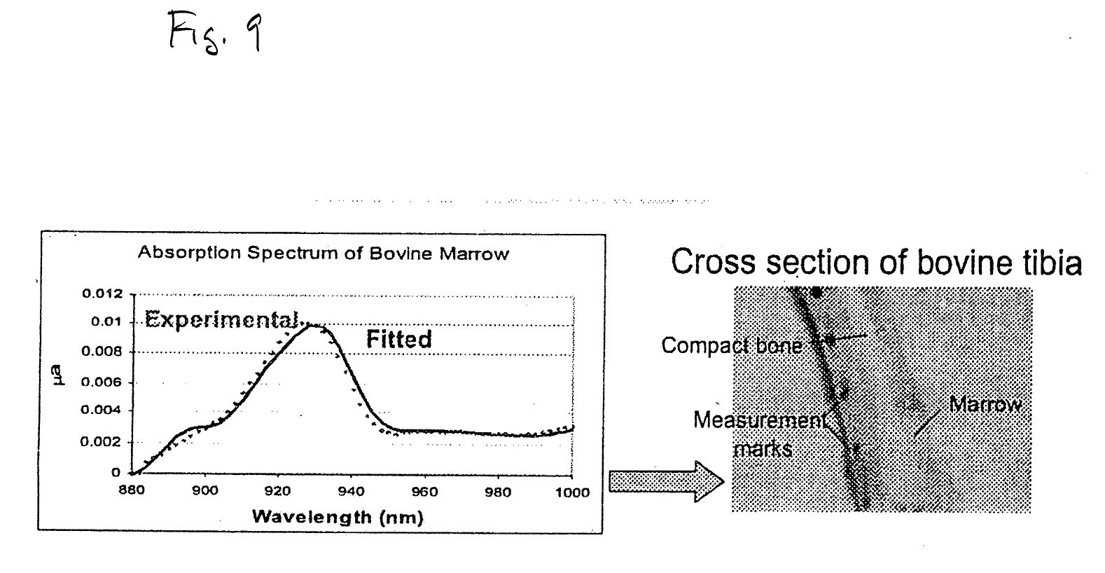

Doppler optical spectroscopy was used directly at measurement points on the marrow by splitting the tibia as shown in the right side of FIG. 9. Steady state-FDPM fits show that the marrow is 90% lipid and produces a blue shift in the lipid peak as seen by the dotted line of experimental data in the left side of FIG. 9.

Identical measurements were made on the right shin of a 27 year old male at 12 measurement locations. Each measurement used a combined frequency-domain photon migration and steady-state instrument measurement procedure as disclosed in U.S. Pat. No. 5,424,843. FDPM data was acquired from 6 laser diodes within the spectral range of 680-850 nm. Source modulation frequencies ranged from 50-400 Mhz. Steady-state spectra were acquired over the 600-1000 nm spectral range. Steady state-FDPM measurements were performed in a reflectance geometry with a 10.5 mm source-to-detector separation for ex vivo measurements and 21.0 mm source-to-detector separation for in vivo measurements. The data fitting procedure was the same as described above.

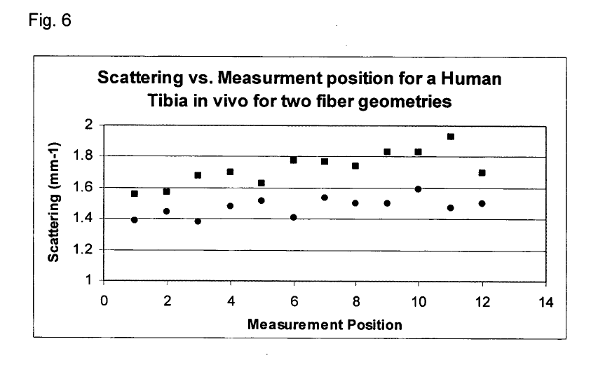

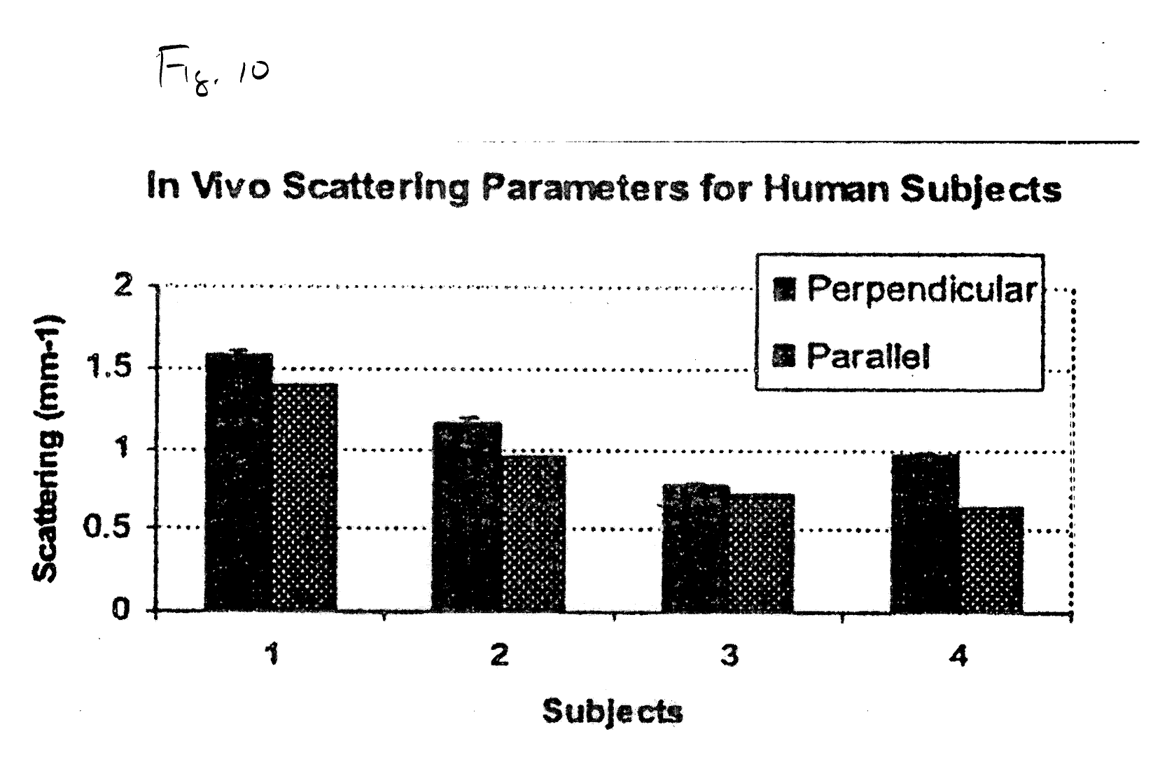

In vivo measurements on a 27 year old male tibia show similar results as depicted in FIG. 6 where the reduced scattering coefficient is graphed against position of measurement. Twelve measurements were made along the right leg at 2 cm intervals and a source-to-detector separation of 21.5 mm was used. Results show the same scattering patterns as ex vivo. There is an average of 18% greater scattering in the perpendicular geometry at all wavelengths (p<0.0001). Scattering results for four different human subjects is shown in the bar graph of FIG. 10 for two fiber geometries of the source and detector.

This difference in scattering properties can be attributed to the directionality of the collagen fibers along the bone. The fibers may “track” the light along the long axis of the bone, thereby contributing to a lower scattering. Hydroxy-apatite aligns along the collagen fibers in the bone and studies with optical coherence tomography have shown that with demineralization of the bone, the difference of scattering with fiber orientation reduces. Thus, this geometry-dependent scattering is dependent upon mineralization. This demonstrates that designing a parameter that ratios perpendicular to parallel scattering from the bone mineral density, or changes in bone mineral density can be monitored using steady state-FDPM. This scattering ratio will decrease with increasing age because bone mineral density drops as the bone weakens.

Monitoring scattering changes can also be used in monitoring cancers of the bone such as osteosarcomas. Osteosarcomas (or osteogenic sarcomas) are the most common cancer of the bone. The lesion can present sclerosis, compression of the surrounding bone and muscle and destruction of bone. These will alter the bone structure which will present as scattering changes. In addition increased vasculature, edema and necrosis will present using steady state-FDPM as increased total hemoglobin concentration and water concentration.

A fully enabled steady state-FDPM system will not be required to provide the above measurements, but a continuous wave system or a simplified version of the steady state-FDPM system will suffice. A device for assessing bone integrity can be made very portable and inexpensive.

Thus this technique will be useful for assessing the integrity of bone in several ways. The ratio of scattering coefficient along the short axis to the scattering coefficient measured along the perpendicular axis can be used as an index to rapidly assess bone health. It is likely that the magnitude of the scattering coefficient in each orientation in addition to the ratio will be valuable as means to report response of bone to therapy, for example as a tool for developing pharmacologic therapies for bone disease such as osteoporosis, osteopinea, osteosarcoma, etc.

Bone strength/health will correlate directly with the magnitude of red-shift in the water absorption peak as described in the data below. The degree of red-shift in the water absorption band can be quantified and is related to the water binding with macromolecules including hydroxyapatite. As the bone matrix breaks down over the course of disease, water will have fewer sites with which to bind. Hence, healthy bone should demonstrate a greater red-shifted water band than diseased bone. This is likely to vary depending on anatomic location.

At the tumor margin in bone, the scattering coefficient is likely to show less heterogeneity as measured for example using the ratio previously discussed in the tumor infiltrated region than in adjacent healthy bone. Thus, measurement of the ratio of scattering coefficients is likely to be a reasonable method of helping to define the margin of bone cancer in the surgical field. Currently there are no other techniques that are used during the process of surgical remediation of bone cancer.

In may now be appreciated that the invention is particularly advantageous over the art in that it is in vivo process. Further, the invention interrogates the entire fingerprint region (600-1100 nm) of the tissue using inexpensive continuous wave and frequency domain apparatus. The ability to gather information over a wide wavelength range using continuous wave and/or frequency domain apparatus (or frequency domain alone) which enables us to assess relative tissue function in addition to structure (“bone density”). The invention is a method for quantizing tissue status, which does not hinge on simple arithmetical differences in tissue transit times of the light.

The invention does not depend on data acquisition techniques such as Raman spectroscopy as a method for quantifying the properties of bone. The chemical information provided by Raman spectroscopy is quite different than that provided by intrinsic optical properties such as absorption and scattering.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method for assessing bone tissue comprising:
exposing a sample to nonionizing radiation;
detecting nonionizing radiation after transit in the bone tissue;
measuring optical properties from the detected nonionizing radiation to characterize bone tissue across an entire selected spectral range using a continuous wave model, a frequency domain model or a combination of both wave model and frequency domain models; and
determining composition, structure, physiology or a combination thereof of bone tissue from the measured optical properties.

2. The method of claim 1 where measuring optical properties comprises measuring optical properties at each point in an entire fingerprint region including at least 600-1100 nm.

3. The method of claim 1 where measuring optical properties comprises measuring optical properties does not depend on arithmetic differences in tissue transit of light.

4. The method of claim 1 where measuring optical properties comprises a method for qualitative and quantitative measurements of optical properties of turbid media using frequency-domain photon migration.

5. The method of claim 1 where measuring optical properties comprises a method for performing quantitative analysis and imaging of subsurface heterogeneities of turbid media using spatially structured illumination.

6. The method of claim 1 where measuring optical properties comprises a method for combined frequency domain photon migration and broadband spectroscopy.

7. The method of claim 1 where measuring optical properties comprises a method for continuous wave broadband spectroscopy at multiple distances.

8. The method of claim 1 further comprising determining disease states based on altered bone characteristics, or determining bone disease progression based thereon.

9. The method of claim 8 where determining disease states comprises comparing bone characteristics between selected bone tissue and selected muscle tissue.

10. The method of claim 8 where determining disease states comprises determining spatial, temporal or compositional variations of bone optical properties.

11. The method of claim 8 where determining disease states comprises comparing absolute values of bone optical properties across a population.

12. The method of claim 1 further comprising correlating the optical properties of bone to provide other measures of bone including T score.

13. The method of claim 1 where measuring optical properties to characterize bone tissue comprises measuring the absorption and reduced scattering coefficients or scattering angular dependence from the bone tissue.

14. The method of claim 1 where measuring optical properties to characterize bone tissue comprises measuring the anisotropy of nonionizing optical scattering in bone.

15. The method of claim 1 where measuring optical properties to characterize bone tissue comprises using broadband DOS to measure absolute absorption spectra and characterize bound water shift in bone.

16. The method of claim 1 where measuring optical properties to characterize bone tissue comprises measuring a blue shift of a lipid absorption peak using Doppler optical spectroscopy (DOS) in bone to separate subcutaneous superficial lipids from lipids in the marrow.

17. The method of claim 1 where measuring optical properties to characterize bone tissue comprises using frequency domain photon migration (FDPM) to measure the absorption and reduced scattering properties of bone in-vivo to determine spectral changes in absorption in order to provide compositional and physiological information about the bone tissue, including a near-infrared absorption spectrum to provide concentrations of oxygenated and deoxygenated hemoglobin, lipids, and water.

18. The method of claim 1 where measuring optical properties to characterize bone tissue comprises measuring spectral changes in reduced scattering including the power and scale factor of near-infrared scattering spectral dependence of tissue as a function of the wavelength to assess bone structure and density.

19. The method of claim 1 where measuring optical properties to characterize bone tissue comprises measuring optical signals in FDPM to assess bone optical properties.

20. The method of claim 1 where determining composition, structure, or physiology of bone from the measured optical properties comprises using models of light transport, physical models, and chemometric analysis of FDPM and spectroscopic signals to determine the bone optical properties.

21. The method of claim 1 where determining composition, structure, or physiology of bone from the measured optical properties comprises using spatially structured illumination to determine the optical properties of bone to determine changes in the optical properties in bone tissue and locate inhomogeneities in bone structure or composition indicative of disease.

22. The method of claim 1 where determining composition, structure, or physiology of bone from the measured optical properties comprises analyzing tissue as a function of wavelength, illumination structure, source modulation frequency or a combination thereof to characterize bone structure and functional status.

23. The method of claim 1 further comprising performing medical diagnostics and bone density assessment based on the measurement and determination of bone tissue optical properties.

24. The method of claim 23 where performing medical diagnostics and bone density assessment comprises monitoring of therapeutic efficacy of hormone therapies and anti-osteoporosis measures.

25. The method of claim 23 where performing medical diagnostics and bone density assessment comprises monitoring changes in bone and muscle status resulting from microgravity.

26. The method of claim 23 where performing medical diagnostics and bone density assessment comprises monitoring efficacy of countermeasures for slowing or reversing the effects of microgravity.

27. The method of claim 23 where performing medical diagnostics and bone density assessment comprises monitoring recovery, healing, or treatment of bone tissue from trauma and atrophy.

28. The method of claim 23 where performing medical diagnostics and bone density assessment comprises screening osteoporosis for purpose of diagnosis or response to therapies.

29. The method of claim 23 where performing medical diagnostics and bone density assessment comprises assessing bone and muscle health in microgravity and responses to therapeutic countermeasures.

30. A apparatus for assessing bone tissue comprising:
a source of nonionizing radiation;
a detector of the nonionizing radiation after transit in the bone tissue;
means for measuring optical properties from the detected nonionizing radiation to characterize bone tissue across an entire selected spectral range using a continuous wave model, a frequency domain model or a combination of both wave model and frequency domain models; and
means for determining composition, structure, physiology or a combination thereof of bone tissue from the measured optical properties.

31. The apparatus of claim 30 where the means for measuring optical properties comprises means for measuring optical properties at each point in an entire fingerprint region including at least 600-1100 nm.

32. The apparatus of claim 30 where the means for measuring optical properties comprises means for measuring optical properties does not depend on arithmetic differences in tissue transit of light.

33. The apparatus of claim 30 where the means for measuring optical properties comprises means for qualitative and quantitative measuring optical properties of turbid media using frequency-domain photon migration.

34. The apparatus of claim 30 where the means for measuring optical properties comprises means for performing quantitative analysis and imaging of subsurface heterogeneities of turbid media using spatially structured illumination.

35. The apparatus of claim 30 where the means for measuring optical properties comprises means for combining frequency domain photon migration measurements and broadband spectroscopic measurements.

36. The apparatus of claim 30 where the means for measuring optical properties comprises means for performing continuous wave broadband spectroscopy at multiple distances.

37. The apparatus of claim 30 further comprising the means for determining disease states based on altered bone characteristics, or for determining bone disease progression based thereon.

38. The apparatus of claim 37 where the means for determining disease states comprises means for comparing bone characteristics between selected bone tissue and selected muscle tissue.

39. The apparatus of claim 37 where the means for determining disease states comprises means for determining spatial, temporal or compositional variations of bone optical properties.

40. The apparatus of claim 37 where the means for determining disease states comprises means for comparing absolute values of bone optical properties across a population.

41. The apparatus of claim 30 further means for comprising correlating the optical properties of bone to provide other measures of bone including T score.

42. The apparatus of claim 30 where the means for measuring optical properties to characterize bone tissue comprises means for measuring the absorption and reduced scattering coefficients or scattering angular dependence from the bone tissue.

43. The apparatus of claim 30 where the means for measuring optical properties to characterize bone tissue comprises means for measuring the anisotropy of nonionizing optical scattering in bone.

44. The apparatus of claim 30 where the means for measuring optical properties to characterize bone tissue comprises means for using broadband DOS to measure absolute absorption spectra and characterize bound water shift in bone.

45. The apparatus of claim 30 where the means for measuring optical properties to characterize bone tissue comprises means for measuring a blue shift of a lipid absorption peak using Doppler optical spectroscopy (DOS) in bone to separate subcutaneous superficial lipids from lipids in the marrow.

46. The apparatus of claim 30 where the means for measuring optical properties to characterize bone tissue comprises means for using frequency domain photon migration (FDPM) to measure the absorption and reduced scattering properties of bone in-vivo to determine spectral changes in absorption in order to provide compositional and physiological information about the bone tissue, including a near-infrared absorption spectrum to provide concentrations of oxygenated and deoxygenated hemoglobin, lipids, and water.

47. The apparatus of claim 30 where measuring optical properties to characterize bone tissue comprises measuring spectral changes in reduced scattering including the power and scale factor of near-infrared scattering spectral dependence of tissue as a function of the wavelength to assess bone structure and density.

48. The apparatus of claim 30 where the means for measuring optical properties to characterize bone tissue comprises means for measuring optical signals in FDPM to assess bone optical properties.

49. The apparatus of claim 30 where the means for determining composition, structure, or physiology of bone from the measured optical properties comprises means for using models of light transport, physical models, and chemometric analysis of FDPM and spectroscopic signals to determine the bone optical properties.

50. The apparatus of claim 30 where the means for determining composition, structure, or physiology of bone from the measured optical properties comprises means for using spatially structured illumination to determine the optical properties of bone to determine changes in the optical properties in bone tissue and locate inhomogeneities in bone structure or composition indicative of disease.

51. The apparatus of claim 30 where the means for determining composition, structure, or physiology of bone from the measured optical properties comprises means for analyzing tissue as a function of wavelength, illumination structure, source modulation frequency or a combination thereof to characterize bone structure and functional status.

52. The apparatus of claim 30 further comprising means for performing medical diagnostics and bone density assessment based on the measurement and determination of bone tissue optical properties.

53. The apparatus of claim 52 where the means for performing medical diagnostics and bone density assessment comprises means for monitoring of therapeutic efficacy of hormone therapies and anti-osteoporosis measures.

54. The apparatus of claim 52 where the means for performing medical diagnostics and bone density assessment comprises means for monitoring changes in bone and muscle status resulting from microgravity.

55. The apparatus of claim 52 where the means for performing medical diagnostics and bone density assessment comprises means for monitoring efficacy of countermeasures for slowing or reversing the effects of microgravity.

56. The apparatus of claim 52 where the means for performing medical diagnostics and bone density assessment comprises means for monitoring recovery, healing, or treatment of bone tissue from trauma and atrophy.

57. The apparatus of claim 52 where the means for performing medical diagnostics and bone density assessment comprises means for screening osteoporosis for purpose of diagnosis or response to therapies.

58. The apparatus of claim 52 where means for performing medical diagnostics and bone density assessment comprises means for assessing bone and muscle health in microgravity and responses to therapeutic countermeasures.
